(19) United States
(12) Patent Application Publication
(10) Pub. No.: US 2007/0193425 A1
(43) Pub. Date: Aug. 23, 2007

(54) Slicing of food products

(75) Inventor: Gunther Weber, Zachow (DE)

Correspondence Address: GIFFORD, KRASS, SPRINKLE,ANDERSON & CITKOWSKI, P.C, PO BOX 7021, TROY, MI, 48007-7021, US

(73) Assignee: Weber Maschinenbau Gmbh & Co. KG, Breidenbach (DE)

(21) Appl. No.: 11/699,664

(22) Filed: Jan. 30, 2007

(30) Foreign Application Priority Data
Feb. 17, 2006 (DE) 10 2006 007 490.4

(51) Int. Cl. B23Q 15/00

(52) U.S. Cl. 83/13; 83/73; 83/367

(57) ABSTRACT

The invention relates to a method for the slicing of food products such as ham, sausage, cheese and the like, in which a product to be sliced is fed in a conveying direction to a cutting knife, in particular a rotatingly driven cutting knife, and slices are cut off the product by means of the cutting knife, and wherein both the outer shape of the product and the inner structure of the product are determined and taken into account in the product feed.

### CROSS-REFERENCE TO RELATED APPLICATIONS

This application claims the benefit of German Patent Application No. 10 2006 007 490.4, filed Feb. 17, 2006. The disclosure of the above application is incorporated herein by reference.

### FIELD

The present invention relates to a method and to an apparatus for the slicing of food products such as ham, sausage, cheese and the like.

### BACKGROUND

The statements in this section merely provide background information related to the present disclosure and may not constitute prior art.

On the slicing of food products, a product to be sliced is fed in a conveying direction to a cutting knife, in particular to a rotatingly driven cutting knife, and slices are cut off from the product by means of the cutting knife.

Portions having a stacked or overlapping shape can be formed from the cut off slices. In a number of cases, the portions are transported away and fed directly to a packaging machine. It is necessary for an efficient processing for this process to run fully automatically and for no correcting interventions to be necessary. The slicing of the food products must therefore take place such that the portions formed can be packaged in unchanged form.

Ever higher demands are being made on the properties of the portions. For instance, the portions should not only have an appealing appearance. It is moreover necessary that the portions maintain a predetermined total weight within relatively tight tolerances. In particular short fillings must be avoided due to legal provisions. In this connection, it can also be necessary to achieve a predetermined total weight with a number of product slices likewise predetermined either precisely or within tight tolerances. It is furthermore possible for each individual product slice to have a predetermined total weight.

To achieve portions or slices of constant weight, it is already known to determine the outer shape or outer contour of the product prior to the slicing and to take this into account in the product feed. Fluctuations in the slice weight on the basis of a non-constant product cross-section profile can thus be balanced by variation of the slice thickness by means of the product feed. In this procedure, a constant product density or a homogeneous density distribution within the product is required.

It is likewise already known to achieve an automatic classification or an automatic so-called grading by an analysis of the cut surfaces of the product slices to be cut off. In this manner, the portions of different product components related to the cut surface can be detected and also evaluated. Meat or lean portions, on the one hand, and fat portions, on the other hand, can be selected as components, for example. Furthermore, hollow spaces inside the product can thus be identified.

### SUMMARY

It is the object of the invention to improve the slicing of food products with respect to a higher versatility and larger flexibility and in particular to achieve a precision which is as high as possible in the production of constant-weight portions or slices.

This object is achieved through a method for the slicing of food products. The method includes determining an outer shape and an inner structure of a product that is to be sliced, feeding the product in a conveying direction to a cutting knife and cutting slices of the product by means of the cutting knife. Both the outer shape of the product and the inner structure of the product are taken into account in the product feeding.

This object is also achieved through an apparatus for the slicing of food products. The apparatus includes a cutting knife, a feed device with which a product that is to be sliced can be fed in a conveying direction to the cutting knife to cut off slices from the product, and measuring devices for determining both an outer shape of the product and an inner structure of the product. Evaluation and control devices are also provided for the operation of the feed device based on the outer shape and the inner structure of the product determined by means of the measuring devices.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

In the method in accordance with the invention for the slicing of food products, both the outer shape of the product and the inner structure of the product are determined and taken into account in the product feed. The slicer apparatus is characterized in that measuring devices are provided for the determination of both the outer shape of the product and the inner structure of the product, and evaluation and control devices serve to operate the feed device with which a product to be sliced is fed in a conveying direction to the cutting knife in dependence on the outer shape and inner structure of the product determined by means of the measuring devices.

The invention is consequently based on the idea of combining information on the outer shape or outer contour of the product, on the one hand, and information on the inner product structure, on the other hand, with one another for the control of the product feed. In a different manner to previously, the product is consequently not only analyzed only with respect to its outer shape or its inner structure, but a complete product detection takes place to the extent that the product is “observed” so-to-say both from the outside and from the inside and the product feed is controlled correspondingly, i.e. the slicing process is controlled correspondingly dynamically.

One is no longer dependent on assumptions on the density distribution of the product thanks to the additional analysis of the inner product structure in accordance with the invention. Hollow spaces or other density anomalies within a product no longer have a disadvantage effect on the total weight of the portions to be observed or on the predetermined slice weight since correcting interventions can be made immediately during the slicing process by a corresponding control of the product feed.

The operation of the product feed can take place solely on the basis of the information obtained by the determination of the outer shape of the product and the inner product structure. In addition, a weighing device can be provided with which the portions formed or the portions arising during the slicing process are weighed. The weight data determined continuously with the scales during the slicing procedure can be taken into account in the control of the feed device. Alternatively, the scales can only serve control purposes.

Specifically, the procedure in accordance with the invention can consist of calculating the weight of a product slice related to a specific slice thickness from the outer shape and the inner structure of the product and to control the product feed such that (i) the product slices to be cut off each have a predetermined slice weight, or (ii) portions of a plurality of product slices each have a predetermined total weight.

It is possible in this process for specific tolerances to be provided for the respectively predetermined values. On the predetermination of a total weight for portions, a predetermined number of product slices can additionally be required.

A slice-related simultaneous taking into account of the outer shape of the product and of the inner product structure is preferred. This total analysis can take place for every individual product slice to be cut off. Alternatively, it is possible only to carry this out for some product slices, for example for every nth product slice, with n being selected in dependence on the respectively desired precision or on the specific properties of the respective product.

The outer shape of the product can be determined at a measuring point disposed in front of the cutting knife in the conveying direction. This can take place directly before the slicing of the product and in particular during the product feed. Generally, however, it is also possible to carry out a product measurement spatially and temporally separate from the actual slicing process.

It is not necessary to measure the whole product with respect to its outer contour. Approximation solutions are also possible here in which, for example, the product is only measured over specific part regions in the longitudinal and/or peripheral direction.

A specific possibility for the determination of the product contour is formed by the so-called light cutting method in which a measurement is made continuously or intermittently with respect to its outer contour, in a measuring plane in particular perpendicular to the conveying direction through which the product is in particular guided directly before this slicing process. For this purpose, a measuring device can be provided which comprises at least one radiation source, for example a laser, with which a line can be projected onto the product as well as a radiation detector, in particular in the form of a video camera. The outer contour of the product can be determined by generally known processes for image processing from the images of the line projected onto the product and detected by means of the radiation detector.

Since the position at which the product contour is determined is known with respect to the cutting place of the cutting knife, all the information is available to the evaluation devices which is required to determine the time at which the product region measured with respect to the contour reaches the cutting plane so that an exact, so-to-say time-offset control of the product feed can take place based on the previously determined product contour data. Alternatively or additionally, it is possible to work with the so-called product start sensors which are arranged both in the region of the measuring point and in the region of the cutting plane and are made to detect the product start disposed at the front in the conveying direction, and then forming a reference for the evaluation and control devices ensuring a correct “timing”.

The determination of the inner product structure can in particular take place by a so-called cut surface analysis. In this process, an image of the cut surface of a slice to be cut off is taken by means of an optoelectronic device, in particular a video camera, and the image is examined with respect to the inner product structure. Fat portions of the product can, for example, thus be distinguished from meat or lean portions and a measure for the weight of the respective slice related to a specific slice thickness can be calculated and taken into account in the product feed while taking account of the known absolute or relative density values. The desired results can be achieved without problem by the use of sufficiently soft hardware and correspondingly powerful software even at high slicing speeds such as are possible with modern high-performance slicers.

Lighting devices for the illumination of the cut surfaces or of the product environment in the region of the cut surfaces can be associated with the video camera and, for example, provide optimum contrasting of the cut surfaces with respect to the environment by the use of different wavelengths or different illumination parameters.

An alternative or additional possibility for the determination of the outer shape of the product consists of detecting the cut surface of a product slice to be cut off and the product environment in the region of this cut surface by means of an optoelectronic detection device, in particular a video camera, and to determine the outline of the respective product slice by distinguishing between the cut surface and the product environment.

This method can in particular be carried out within the framework of the previously explained cut surface analysis for the determination of the inner product structure.

Independently of which methods are used for the determination of the outer contour and of the inner contour of the product, it is possible in accordance with the invention to determine the outer contour and inner contour for each product slice to be cut off and to use them for the control of the product feed in order to control the slicing process with the highest possible degree of precision and flexibility in this manner.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for the slicing of food products, comprising:
determining an outer shape and an inner structure of a product that is to be sliced;
feeding the product in a conveying direction to a cutting knife; and
cutting slices of the product by means of the cutting knife, wherein both the outer shape of the product and the inner structure of the product are taken into account in the product feeding.

2. A method in accordance with claim 1, further comprising calculating a weight of a product slice relative to a specific slice thickness based on the outer shape and the inner structure of the product, wherein the feeding of the product is controlled such that the product slices to be cut off each have a predetermined slice weight.

3. A method in accordance with claim 1, further comprising calculating a weight of a product slice relative to a specific slice thickness based on the outer shape and the inner structure of the product, wherein the feeding of the product is controlled such that portions of a plurality of product slices each have a predetermined total weight, in particular while taking account of a predetermined number of product slices.

4. A method in accordance with claim 1, wherein both the outer shape and the inner structure are taken into account for the product feeding for at least some product slices.

5. A method in accordance with claim 1, wherein the outer shape of the product is determined at a measuring point disposed in front of the cutting knife in the conveying direction.

6. A method in accordance with claim 1, wherein the outer shape of the product is determined while the product is fed to the cutting knife.

7. A method in accordance with claim 1, wherein the outer shape of the product is determined in a measuring plane through which the product is moved.

8. A method in accordance with claim 7, wherein the measuring plane extends perpendicular to the conveying direction.

9. A method in accordance with claim 1, wherein the inner structure of the product is determined by cut surface analysis.

10. A method in accordance with claim 1, wherein cut surfaces of at least some product slices are each analyzed before the cutting off of the product slice.

11. A method in accordance with claim 1, wherein cut surfaces are detected by means of an optoelectronic device and cut surface images obtained in this process are evaluated with respect to the inner product structure.

12. A method in accordance with claim 1, wherein a contour of a product slice that is to be cut off is in each case detected by means of an optoelectronic detection device for the determining the outer shape of the product, and wherein the cut surface of the product slice is distinguished from the product environment in images that are taken by means of the camera.

13. An apparatus for the slicing of food products, comprising:
a cutting knife;
a feed device with which a product that is to be sliced can be fed in a conveying direction to the cutting knife to cut off slices from the product;
measuring devices for determining both an outer shape of the product and an inner structure of the product, and
evaluation and control devices for the operation of the feed device based on the outer shape and the inner structure of the product determined by means of the measuring devices.

14. An apparatus in accordance with claim 13, wherein the measuring, evaluation and control devices are made to take into account both the outer shape and the inner structure for the product feed for at least some product slices.

15. An apparatus in accordance with claim 13, wherein at least one measuring device for the determination of the outer shape of the product is arranged at a measuring point disposed in front of the cutting knife in the conveying direction.

16. An apparatus in accordance with claim 13, wherein the measuring devices are made to determine the outer shape of the product by measurement of the product contour in a measuring plane through which the product can be moved.

17. An apparatus in accordance with claim 13, wherein the measuring device includes at least one radiation source, with which a line can be projected onto the product, and a radiation detector with the outer contour of the product being able to be determined using the evaluation devices from an image of the line projected onto the product taken by means of the radiation detector.

18. An apparatus in accordance with claim 13, wherein the measuring, evaluation and control devices are made for analyzing a cut surface.

19. An apparatus in accordance with claim 13, wherein the measuring devices include at least one optoelectronic detection device, which is arranged in a half-space disposed after the cutting knife in the conveying direction and is made for detecting cut surfaces of the product slices that are to be cut off.

20. An apparatus in accordance with claim 13, wherein the evaluation devices are made to evaluate detected cut surface images with respect to the inner structure.

21. An apparatus in accordance with claim 13, wherein the evaluation devices are made to evaluate detected cut surface images with respect to the product contour.

22. An apparatus in accordance with claim 13, wherein lighting devices matched to the measuring devices are provided for illuminating at least one of the cut surfaces and the product environment in the region of the cut surfaces.
